(19) United States
(12) Patent Application Publication
(10) Pub. No.: US 2014/0359992 A1
(43) Pub. Date: Dec. 11, 2014

(54) SEMI-AUTOMATIC STATION FOR EXCHANGING THE TRACTION BATTERY OF AN ELECTRIC OR HYBRID VEHICLE

(71) Applicant: RENAULT s.a.s, Boulogne-Billancourt (FR)

(72) Inventor: Gilles Mulato, Chatillon (FR)

(73) Assignee: RENAULT s.a.s, Boulogne-Billancourt (FR)

(21) Appl. No.: 14/356,493

(22) PCT Filed: Nov. 6, 2012
(86) PCT No.: PCT/EP2012/071945

§ 371 Date: Jul. 16, 2014

(30) Foreign Application Priority Data
Nov. 7, 2011 (FR) 1160063

(51) Int. Cl. B60S 5/06

(52) U.S. Cl. CPC B60S 5/06
USPC 29/402.08; 29/822

(57) ABSTRACT

The invention notably relates to a method and device allowing an operator to exchange a discharged traction battery (113) of an electric or hybrid vehicle (3) for a recharged traction battery (114). The device comprises a pit in which are located lifting means (21) for lifting the vehicle, which comprise means (219) for immobilizing the vehicle in a reference position with respect to the direction longitudinal to the vehicle (X) and means (219, 220, 221) for immobilizing the vehicle in a reference position with respect to the direction transverse to the vehicle (Y). The device also comprises means for immobilizing the vehicle in a reference position with respect to the vertical direction (Z) and lifting means (24) for raising and lowering means for unlocking the discharged battery from the vehicle or locking the recharged battery to the vehicle.

The present invention concerns a semi-automatic station for exchange of a traction battery. It applies in particular to electric or hybrid vehicles.

Current electric vehicles, in particular those using a lithium-ion (Li-ion) battery as a traction battery, still have limited range, in any case substantially below the range of the majority of vehicles with internal combustion engines. This is a problem which the present invention proposes to solve.

With the aim of solving this range problem, battery exchange stations for electric carriages were installed at the end of the 19th century in the United States. These very first battery exchange stations are described in the work of David A. Kirsch, published in 2000 and entitled “The electric vehicle and the burden of History”. The cab of the carriage was first raised in order to be separated from a platform supported on wheels, which itself carried the electric motor and its battery. Then the discharged battery was itself raised and a recharged battery fitted in its place. All these heavy handling operations required the intervention of several operators who lifted and removed the cab of the carriage and the batteries, using lifting gear of the workshop-crane type or a pulley block. A major drawback of these first stations was the lack of automation, which made the time necessary to exchange a battery highly variable depending on the number and experience of the operators available. This is another problem which the present invention proposes to solve.

With the aim of solving this problem of exchange time, rapid exchange stations have been proposed such as the station described in patent U.S. Pat. No. 5,612,606 published on March 1997, such that the exchange time of the battery of an electric vehicle becomes substantially equivalent to the time for filling the fuel tank of a vehicle with an internal combustion engine. This rapid station allows rapid exchange of the battery of an electric vehicle comprising a traction battery which is removable from below the vehicle. It comprises means of aligning the vehicle in relation to means of lifting the battery, these means including heavy lifting means allowing an initial approach of the battery to below the vehicle, and finer lifting means allowing precise positioning of the battery below the vehicle. This rapid station also comprises means for moving the batteries in one direction or the other between the lifting zone and a recharging zone. A major drawback of this fully automated, rapid exchange station is the very high cost of installation and maintenance. In fact these costs make it difficult to depreciate the station financially, in particular in countries in development or in emerging countries where the vehicle fleet is restricted. In these countries, use of a motor vehicle, either with an internal combustion engine or electric, remains reserved for a very favored fraction of the population. Such stations cannot be depreciated within a reasonable time except in developed countries where the vehicle fleet is very widespread. This is another problem which the present invention proposes to solve.

The object of the invention is in particular to limit the cost of installation and maintenance of the exchange station, such that it can be used profitably in countries in development and in emerging countries. To do this, a guiding principle of the invention is to create a semi-automatic station for exchange of a battery removable from below the vehicle, which does not require the intervention of more than one operator. To this end, the object of the invention is a device allowing an operator to exchange a discharged traction battery of an electric or hybrid vehicle for a recharged traction battery. The device comprises a pit in which are arranged vehicle-lifting means allowing the vehicle to be raised or lowered. These lifting means comprise means for immobilizing the vehicle in a reference position in relation to the longitudinal direction of the vehicle, and means for immobilizing the vehicle in a reference position in relation to the transverse direction of the vehicle (Y). Also arranged in the pit are means for immobilizing the vehicle in a reference position in relation to the vertical direction, and lifting means allowing raising and lowering of means for unlocking the discharged battery from the vehicle or locking the recharged battery to the vehicle. Outside the pit, the device comprises means for access by the vehicle to the vehicle-lifting means. The device also comprises, outside the pit, handling means allowing the operator to transport the discharged battery between the top of the pit and a charging zone and/or to transport the recharged battery between the charging zone and the top of the pit.

Advantageously, the pit may have a depth of less than or equal to 1.5 meters.

For example, the lifting means may include a lift ramp comprising a plurality of columns and two horizontal support ramps able to support the vehicle when stopped.

Advantageously, the means for immobilizing the vehicle in a reference position in relation to the longitudinal direction of the vehicle can include at least one pair of sleeved rollers, the rotation axes of which are oriented along the transverse direction of the vehicle, these rollers being able to receive and block a rear wheel of the vehicle when said rear wheel rolls on one of the two horizontal support ramps.

Advantageously, the means for immobilizing the vehicle in a reference position in relation to the transverse direction of the vehicle can include the pair of sleeved rollers, a manual alignment bar which may comprise a pull handle arranged so as to pull the vehicle in the transverse direction of the vehicle, and a support stop against the inside of the wheels, arranged along the longitudinal direction of the vehicle, and rollers of which the rotation axes may be oriented along the longitudinal direction of the vehicle, these rollers being able to receive the front wheels of the vehicle.

Advantageously, the means for immobilizing the vehicle in a reference position in relation to the vertical direction may include a plurality of guide elements able to be received by guide and support elements arranged below the body of the vehicle.

Advantageously, the lifting means allowing raising and lowering of the means for unlocking the discharged battery from the vehicle or locking the recharged battery to the vehicle may include a lifting platform.

Advantageously, the means for access by the vehicle to the vehicle-lifting means may include two inclined access ramps.

Advantageously, the handling means may include a forklift truck.

The object of the invention is also a method allowing an operator to remove a discharged traction battery from an electric or hybrid vehicle and to put it on charge. The method comprises a step of access by the vehicle to lifting means allowing raising or lowering of said vehicle, these lifting means being arranged in a pit. It also comprises a step of immobilizing the vehicle on the vehicle-lifting means in a reference position in relation to the longitudinal direction of the vehicle and in a reference position in relation to the transverse direction of the vehicle. It also comprises a step of lowering the vehicle by the lifting means so as to bring the vehicle into cooperation with the means for immobilizing the vehicle in a reference position in relation to the vertical direction. It also comprises a step of raising, by lifting means, the means for unlocking the discharged battery. It also comprises a step of unlocking the discharged battery by the unlocking means. The method also comprises a step of lowering, by the lifting means, to a height substantially level with the top of the pit, the means for unlocking the discharged battery when said unlocking means are supporting said battery. The method also comprises a step of transporting the discharged battery using handling means by the operator between the top of the pit and a charging zone.

The object of the invention is also a method allowing an operator to install a recharged traction battery in an electric or hybrid vehicle. The method comprises a step of transporting the recharged battery between a charging zone and a pit in which lifting means are arranged allowing raising or lowering of the vehicle. The method also comprises a step of raising, by the lifting means also arranged in the pit, the means for locking the recharged battery, these means also being arranged in the pit (2), and said battery. The method also comprises a step of locking the recharged battery by the locking means. The method also comprises a step of lowering the locking means by the lifting means. The method also comprises a step of raising the vehicle by the lifting means so as to release the vehicle from the means for immobilizing said vehicle in a reference position in relation to the vertical direction. The method also comprises a step of evacuation by the vehicle from the lifting means. The step of transporting the battery is carried out using handling means by the operator so as to transport the battery substantially above the pit.

The present invention has a further principal advantage that it does not require any particular qualification of its sole operator, who may be trained within just a few hours in the use of an exchange station according to the invention. This proves particularly advantageous in countries in development or emerging countries in which the workforce seeking employment is generally poorly qualified or totally unskilled. Finally and above all, an exchange station according to the invention never replaces employment in any of these countries. In fact the pump operator already employed need merely be retrained into an exchange station operator according to the invention, or an operator must be recruited.

Other characteristics and advantages of the invention will appear from the description below in relation to the attached drawings in which:

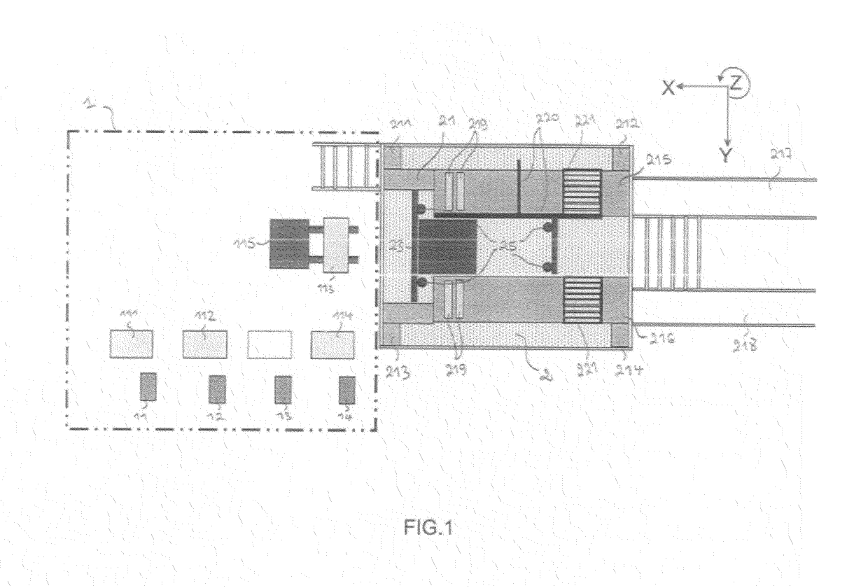

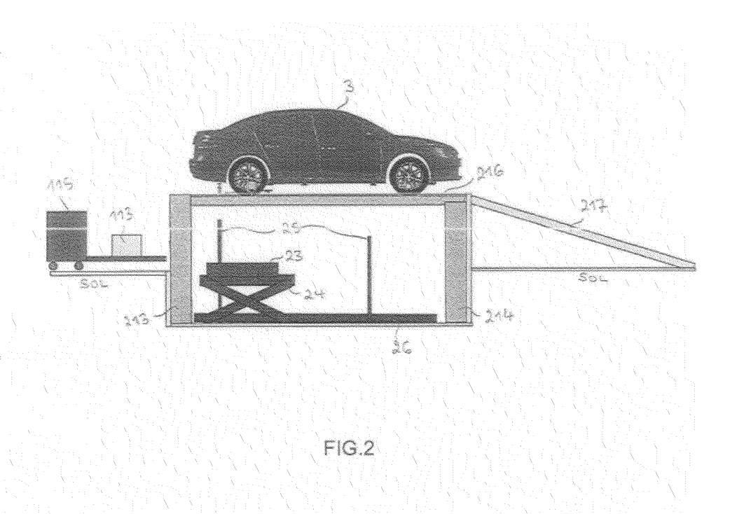

FIGS. 1 and 2 show, by overall diagrammatic depictions, an example of a station according to the invention,

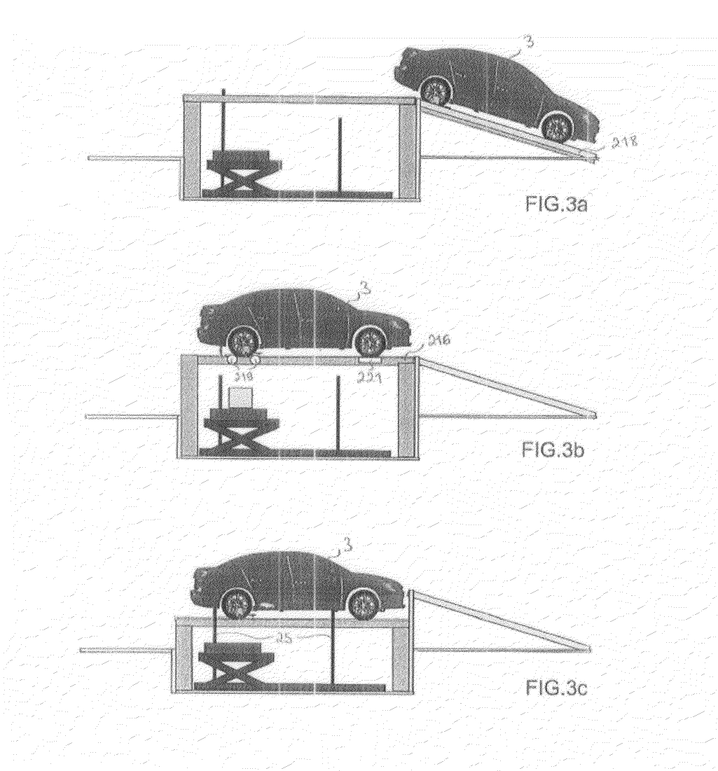

FIGS. 3a, 3b, 3c, 3d, 4a, 4b, 4c, 4d, 5a, 5b, 5c, 5d, 6a, 6b, 6c and 6d show, by diagrammatic profile depictions, an exemplary embodiment of the method according to the invention.

FIGS. 1 and 2 show diagrammatically an example of an exchange station according to the invention comprising a storage zone 1 substantially 6 meters wide and 7 meters long, which receives four charging stations 11, 12, 13 and 14 which can simultaneously recharge four traction batteries 111, 112, 113 and 114 respectively.

The exchange station also comprises a pit 2 adjacent to the storage zone 1, the pit 2 being substantially 4 meters wide and 5 meters long, so as to receive a lift ramp 21 comprising in particular four columns 211, 212, 213 and 214 and two horizontal support ramps 215 and 216 able to support a motor vehicle 3 when stopped, the discharged battery 113 of which can be removed from below. A forklift truck 115 for example allows transport of the battery 113 and any of the other batteries 111, 112 and 114 between the pit 2 and the charging station 13 in one direction or the other. Advantageously the pit 2 is of reduced depth of maximum 1.5 meters, which allows a drastic reduction in the cost of installation of the station. Columns 211, 212, 213 and 214 of the lift ramp 21 are only placed in the pit 2 to half their height, and the vehicle 3 is situated only between 1.5 and 2 meters from ground level when the lift ramp 21 is in the high position. In this high position of the lift ramp 21, the horizontal support ramps 215 and 216 are accessible by the vehicle via two inclined access ramps 217 and 218 respectively, which are able to support the vehicle 3 when moving. Each of the horizontal support ramps 215 and 216 is fitted with a pair of rollers 219, the axes of rotation of which are oriented along a direction Y transverse to the vehicle 3. Each of the roller pairs 219 is able to receive and support one of the rear wheels of the vehicle 3 in order to automatically stop its progression on the ramps 215 and 216 in a reference position in relation to a direction X longitudinal to the vehicle 3. The rollers 219 are sleeved rollers, i.e. they are mounted movably on their respective rotation axes, these axes being longer than the rollers themselves so as to allow a movement in direction Y of the roller pairs 219 and the vehicle 3 which they support. Thus when a force is applied to the vehicle 3 in direction Y via a manual alignment bar 220, comprising a manual pull handle arranged in direction Y and a support stop against the inside of the wheels arranged in direction X, the vehicle 3 is driven in movement in direction Y. The rollers 221, the rotation axes of which are oriented in direction X, are able to receive the front wheels of the vehicle 3 and allow them to slide in direction Y up to a reference position. In the low position of the lift ramp 21, the vehicle 3 rests on four guide elements 25 supported by a carriage 26 arranged in the base of the pit 2, the guide elements 25 being received by guide and support elements arranged below the body of the vehicle 3 so as to immobilize the vehicle 3 in a substantially horizontal reference position in relation to a vertical direction Z. Because they are arranged below the body of the vehicle 3, the guide and support elements are not visible on the present figures. In the present embodiment, the forklift truck 115 allows removal of the battery 111, 112, 113 or 114 on a tool 23, or lifting of this tool 23. The tool 23 is a dedicated tool allowing locking or unlocking of the battery 111, 112, 113 or 114 of the vehicle 3. It is supported by a lifting platform 24, itself supported by the carriage 26 arranged in the base of the pit 2. The tool 23 and the lifting platform 24 are arranged on the carriage 26 such that they can pass between the horizontal support ramps 215 and 216 when the lift ramp 21 is in the low position.

FIGS. 3a, 3b, 3c, 3d, 4a, 4b, 4c, 4d, 5a, 5b, 5c, 5d, 6a, 6b, 6c and 6d show an example of the method according to the invention for exchanging the battery of the vehicle 3.

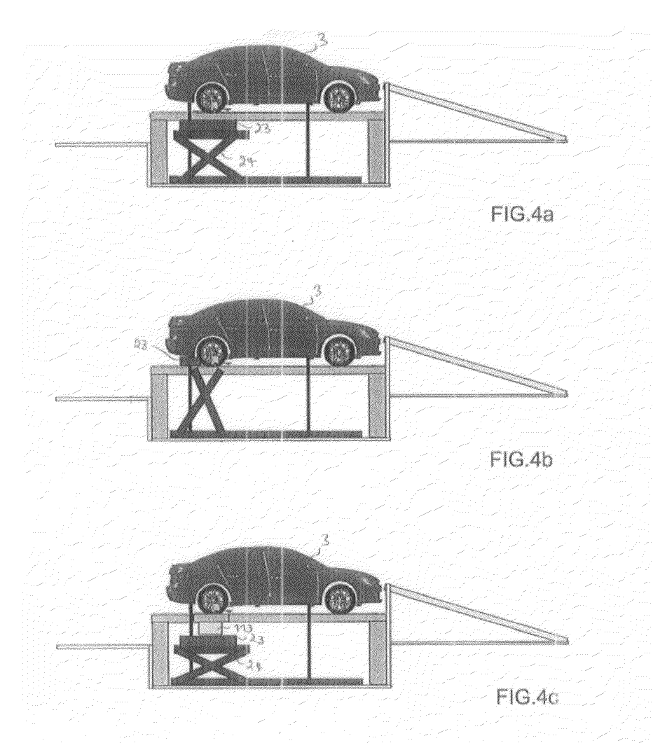

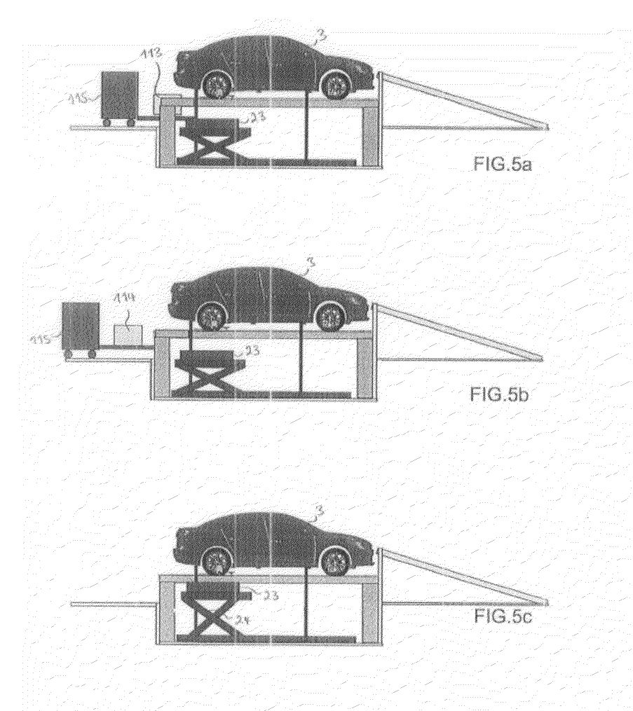

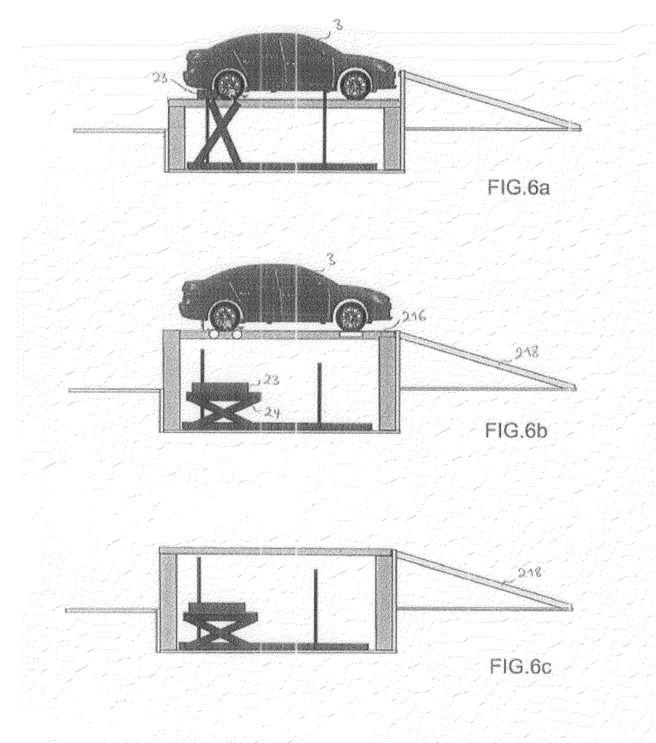

As shown on FIG. 3a, the vehicle 3 first reverses onto the inclined access ramps 217 and 218. Then as shown on FIG. 3b it accesses the support ramps 215 and 216 where the roller pairs 219 block it automatically in the reference position in relation to direction X. Then an operator, not shown on the figures, manually pulls the pull handle of the alignment bar 220, the stop of which then comes to rest virtually simultaneously against the inside of the front left wheel and against the inside of the rear left wheel of the vehicle 3, which then slides on the sleeve mechanisms of the roller pairs 219 and on the rollers 221 before being immobilized in the reference position in relation to direction Y. Then as shown on FIG. 3c, the lift ramp 21 lowers the vehicle 3 until the four guide elements 25 come to rest against the guide and support elements situated below the vehicle 3, the latter elements not being shown on the figures, thus immobilizing the vehicle 3 in a substantially horizontal reference position in relation to direction Z. Then as shown on FIG. 4a, the lifting platform 24 lifts the tool 23 until it comes to rest against the guide and support elements arranged below the battery 113, the latter guide and support elements also not being shown on the figures, wherein the battery 113 is the almost discharged battery mounted on the vehicle 3 in the present exemplary embodiment of the method according to the invention. Then as suggested by FIG. 4b, automatic unlocking mechanisms for the tool 23—these mechanisms not forming the subject of the present application—are used so as to release the battery 113 from the vehicle 3. Exemplary embodiments of the tool 23 are given for example in international application WO 2011/058256 A1 filed by the applicant. Then as shown on FIG. 4c, the lifting platform 24 lowers the tool supporting the battery 113 until the tool 23 is substantially at ground level. Then as shown on FIG. 5a, the forklift truck 115 removes the discharged battery 113 from the tool 23. Then as shown on FIG. 5b, the forklift truck 115 brings the recharged battery 114 and places it on the tool 23. Then as shown on FIG. 5c, the lifting platform 24 raises the tool 23 supporting the battery 114 until the battery 114 comes to rest against the guide, support and locking elements situated below the vehicle 3, the latter elements not being shown on the figures. Then as suggested by FIG. 6a, automatic locking mechanisms of the tool 23—these mechanisms not forming the subject of the present application—are used so as to connect the battery 114 to the vehicle 3. Then as shown on FIG. 6b, the lifting platform 24 lowers the tool 23 again substantially to ground level and the lift ramp 21 raises the vehicle 3 so as to bring the support ramps 215 and 216 to the level of the access ramps 217 and 218. Finally, as suggested by FIG. 6c, the vehicle 3 descends the access ramps 217 and 218 and leaves the exchange station with maximum range.

1. A device allowing an operator to exchange a discharged traction battery of an electric or hybrid vehicle for a recharged traction battery, the device comprising:
a pit in which are arranged:
vehicle-lifting means allowing the vehicle to be raised or lowered, said lifting means comprising:
means for immobilizing the vehicle in a reference position in relation to the longitudinal direction of the vehicle;
means for immobilizing the vehicle in a reference position in relation to the transverse direction of the vehicle;
means for immobilizing the vehicle in a reference position in relation to the vertical direction;
lifting means for raising and lowering means for unlocking the discharged battery from the vehicle or locking the recharged battery to the vehicle;
outside the pit, means for access by the vehicle to the vehicle-lifting means;
outside the pit, handling means allowing the operator to transport the discharged battery between the top of the pit and a charging zone and/or to transport the recharged battery between the charging zone and the top of the pit.

2. The device as claimed in claim 1, wherein the pit has a depth of less than or equal to 1.5 meters.

3. The device as claimed in claim 1, wherein the lifting means include a lift ramp comprising:
a plurality of columns;
two horizontal support ramps able to support the vehicle when stopped.

4. The device as claimed in claim 3, wherein the means for immobilizing the vehicle in a reference position in relation to the longitudinal direction of the vehicle include at least one pair of sleeved rollers, the rotation axes of which are oriented along the transverse direction of the vehicle, these rollers being able to receive and block a rear wheel of the vehicle when said rear wheel rolls on one of the two horizontal support ramps.

5. The device as claimed in claim 4, wherein the means for immobilizing the vehicle in a reference position in relation to the transverse direction of the vehicle include:
the pair of sleeved rollers;
a manual alignment bar comprising:
a pull handle arranged so as to pull the vehicle in the transverse direction of the vehicle;
a support stop against the inside of the wheels, arranged along the longitudinal direction of the vehicle;
rollers of which the rotation axes are oriented along the longitudinal direction of the vehicle, these rollers being able to receive the front wheels of the vehicle.

6. The device as claimed in claim 1, wherein the means for immobilizing the vehicle in a reference position in relation to the vertical direction include a plurality of guide elements able to be received by guide and support elements arranged below the body of the vehicle.

7. The device as claimed in claim 1, wherein the lifting means allowing raising and lowering of the means for unlocking the discharged battery from the vehicle or locking the recharged battery to the vehicle include a lifting platform.

8. The device as claimed in claim 1, wherein the means for access by the vehicle to the vehicle-lifting means include two inclined access ramps.

9. The device as claimed in claim 1, wherein the handling means include a forklift truck.

10. A method allowing an operator to remove a discharged traction battery from an electric or hybrid vehicle and to put it on charge, the method comprising:
a step of access by the vehicle to lifting means allowing raising or lowering of said vehicle, said lifting means being arranged in a pit;
a step of immobilizing the vehicle on the vehicle-lifting means in a reference position in relation to the longitudinal direction of the vehicle and in a reference position in relation to the transverse direction of the vehicle;
a step of lowering the vehicle by the lifting means so as to bring the vehicle into cooperation with the means for immobilizing the vehicle in a reference position in relation to the vertical direction;
a step of raising, by lifting means, the means for unlocking the discharged battery;
a step of unlocking the discharged battery by the unlocking means;
the method further comprising:
a step of lowering, by the lifting means, to a height substantially level with the top of the pit, the means for unlocking the discharged battery when said unlocking means are supporting said battery;
a step of transporting the discharged battery using handling means by the operator between the top of the pit and a charging zone.

11. A method allowing an operator to install a recharged traction battery in an electric or hybrid vehicle, the method comprising:
a step of transporting the recharged battery WO between a charging zone and a pit in which lifting means are arranged allowing raising and lowering of the vehicle;
a step of raising, by the lifting means also arranged in the pit:
the means for locking the recharged battery, these means also being arranged in the pit; and
said battery;
a step of locking the recharged battery by the locking means;
a step of lowering the locking means by the lifting means;
a step of raising the vehicle by the lifting means so as to release the vehicle from the means for immobilizing said vehicle in a reference position in relation to the vertical direction;
a step of evacuation by the vehicle from the lifting means;
wherein the step of transporting the battery is carried out using handling means by the operator so as to transport the battery substantially above the pit.
